(19) United States
(12) Patent Application Publication
(10) Pub. No.: US 2011/0208387 A1
(43) Pub. Date: Aug. 25, 2011

(54) System and On-Board Unit For Integrating Functions of Vehicle Devices

(75) Inventors: Ralf Bosch, Rottweil (DE); Dirk Gandras, Gottmadingen (DE); Gunnar Schmidt, Villingen-Schwenningen (DE)

(73) Assignee: Continental Automotive GmbH, Hannover (DE)

(21) Appl. No.: 13/119,899

(22) PCT Filed: Sep. 18, 2009
(86) PCT No.: PCT/EP2009/062117

§ 371 Date: Mar. 18, 2011

(30) Foreign Application Priority Data
Sep. 19, 2008 (DE) 10 2008 048 162.9

(51) Int. Cl. G06F 7/00

(52) U.S. Cl. 701/35

(57) ABSTRACT

An on-board unit, which is in the form of a tachograph, and includes at least one position-finding device and/or at least one radio communication device which can be coupled to the on-board unit for the purpose of use by the on-board unit or are included by the latter. The on-board unit has at least one function of at least one of the following vehicle devices, and the on-board unit is designed to replace the respective vehicle device in terms the at least one function which is one of a toll collection device, an event data capture device, an emergency call device, a transport monitoring device, a vehicle course monitoring device, and a fleet management device.

### PRIORITY CLAIM

This is a U.S. national stage of Application No. PCT/EP2009/062117, filed on Sep. 18, 2009, which claims priority to German Application No: 10 2008 048 162.9, filed: Sep. 19, 2008, the contents of which are incorporated herein by reference.

### BACKGROUND OF THE INVENTION

1. Field of the Invention

The invention relates to a system that comprises a tachograph, and to an on-board unit for the system, which on-board unit is embodied as a tachograph. The system is provided for arrangement in a vehicle.

2. Related Art

A digital tachograph for monitoring driving times and rest times as well as permissible maximum speeds in vehicles over 3.5 tonnes is prescribed, at least within the European Union. In addition, such vehicles are increasingly also equipped with an on-board toll collection unit. In future, equipment with a tachograph and an on-board toll collection unit could also be prescribed for passenger cars.

### SUMMARY OF THE INVENTION

An object of one embodiment of the invention is to provide a system that is simple and reliable. In addition, an object of the invention is to provide an on-board unit which makes possible a simple and reliable system.

One embodiment of invention is a system that comprises an on-board unit that is embodied as a tachograph. The invention is also distinguished by such an on-board unit. The system comprises at least one position-determining device and/or at least one radio communication device which, for the purpose of use by the on-board unit, can be coupled to the on-board unit or included in the latter. The on-board unit has at least one function of at least one of the following vehicle devices: toll collection unit, event data capture device, emergency call device, transport monitoring device, vehicle course monitoring device, and fleet management device. The on-board unit is designed to replace the respective vehicle device in terms of this at least one function.

Therefore, the system can be particularly simple and reliable. In addition, the system can also be particularly cost-effective. In particular, the respective vehicle device can also be particularly cost-effective.

One embodiment of the invention is that the tachograph is, at least in the European Union, already prescribed for vehicles over 3.5 t, and is therefore provided in such vehicles for monitoring driving times and rest times as well as permissible maximum speeds. Vehicle devices, in particular for example the toll collection unit and/or the event data capture device and/or the emergency call device and/or the transport monitoring device, can also be prescribed. In addition, the toll collection unit, the emergency call device, the transport monitoring device, the vehicle course monitoring device, the fleet management device and, if appropriate, the event data capture device require access to a position-determining device and/or radio communication device. In addition, the tachograph is of particularly safe and reliable design and is coupled to sensors for securely storing measured values, for example of a velocity. By virtue of the fact that the tachograph has the at least one function of the at least one vehicle component and replaces the vehicle component in this respect, the respective vehicle component no longer needs to have this at least one of its functions and can therefore be embodied in a particularly simple and cost-effective way. The system with the on-board unit forms a uniform platform for the integration of functions of vehicle devices. Components of vehicle devices or even entire vehicle devices can be replaced by the system and therefore eliminated. The system preferably also comprises the at least one vehicle component whose at least one function the on-board unit has. In addition, this at least one vehicle component is coupled to the on-board unit, for example via a vehicle data bus, or is included in the on-board unit.

In one advantageous refinement, the on-board unit has in each case at least one function of at least two of the vehicle devices. These at least two of the vehicle devices make joint use of the at least one position-determining device and/or of the at least one radio communication device. The advantage is that as a result the at least one position-determining device and/or the at least one radio communication device has to be present only once in the vehicle. In this way, the respective vehicle device can be of simple and cost-effective design. For example, it is possible to provide that one of the vehicle devices or the on-board unit includes the at least one position-determining device and/or the at least one radio communication device. However, it is also possible to provide that the at least one position-determining device and/or the at least one radio communication devices is embodied as a separate module, that is to say said devices are not associated with any of the vehicle devices or the on-board unit and the at least one position-determining device and/or the at least one radio communication device and the at least one vehicle component are coupled to the on-board unit.

In a further advantageous refinement, the at least one function comprises a user interface. By virtue of the fact that the on-board unit has the user interface of at least one of the vehicle devices, this respective vehicle device no longer has to have the user interface and can therefore be embodied in a particularly simple and cost-effective way. In addition, this respective vehicle device also does not have to be arranged in an easily accessible place in the vehicle in order to be operated. As a result, the location or installation of this respective vehicle device can also be particularly simple and cost-effective. The user interface can include, for example, a display and/or at least one operator control element.

In a further advantageous refinement, the at least one function comprises data storage. The advantage is that the tachograph is already designed for secure and reliable storage, and the tachograph can therefore also very easily store data of the respective vehicle device. This respective vehicle device then does not have to be designed to store data and can therefore be embodied in a particularly simple and cost-effective way.

In this context it is advantageous if the on-board unit is designed to secure the data storage cryptographically by signing and/or encryption. The advantage is that the tachograph is already designed to sign and/or encrypt data cryptographically. The tachograph can therefore also very easily correspondingly securely store data of the respective vehicle device. This respective vehicle device then does not have to be designed to store data in a cryptographically signed and/or encrypted fashion, and can therefore be embodied in a particularly simple and cost-effective way.

In a further advantageous refinement, the at least one function comprises data communication via the at least one radio communication device. This has the advantage that the respective vehicle device does not have to be designed to carry out data communication via at least one radio communication device, and in particular does not itself have to have any radio communication device. This respective vehicle device can therefore be embodied in a particularly simple and cost-effective way.

In this context, it is advantageous if the on-board unit is designed to sign and/or check and/or encrypt and/or decrypt the data communication cryptographically. The advantage is that the tachograph is already designed to sign and/or check and/or encrypt and/or decrypt data cryptographically. The tachograph can therefore also very easily correspondingly process data for the data communication of the respective vehicle device. This respective vehicle device then does not have to be designed to transmit or receive data in a cryptographically signed and/or checked and/or encrypted and/or decrypted fashion, and can therefore be embodied in a particularly simple and cost-effective way.

In a further advantageous refinement, the at least one function comprises a position-determining process by the at least one position-determining device. This has the advantage that the respective vehicle device does not have to be designed to carry out the position-determining process by at least one position-determining device, and in particular itself does not have to have any position-determining device. This respective vehicle device can therefore be embodied in a particularly simple and cost-effective way.

In a further advantageous refinement, the on-board unit is designed to replace the at least one vehicle device completely by recourse to the at least one position-determining device and/or the at least one radio communication device. The advantage is that the separately embodied vehicle device is no longer necessary, with the result that the latter consequently also does not require any installation space and no costs are incurred for it. A functionality of this respective vehicle device is completely integrated into the on-board unit. The system can therefore be particularly simple and reliable.

In a further advantageous refinement, the at least one radio communication device is designed to carry out data communication with a respectively corresponding radio communication device in at least one other vehicle. As a result, car-to-car communication is possible. As a result, improved traffic flow in particular, or an accident warning, traffic jam warning, black ice warning or fog warning are possible with a high degree of up-to-dateness and relevance owing to local dissemination of such data under close to real-time conditions.

In a further advantageous refinement, the at least one radio communication device is designed to carry out data communication via at least one mobile radio base station. This makes data communication possible even over large distances.

In a further advantageous refinement, the system is designed, as is correspondingly the on-board unit, to transmit, via the at least one radio communication device, a current position which is determined by the at least one position-determining device, and/or a distance which has been traveled and/or a speed information item and/or an accident warning and/or an emergency call and/or information relating to driving times and rest times and/or a payload weight and/or a cargo space temperature and/or a fuel consumption value. In this way, data and information of this kind can also be made available on an up-to-date basis outside the vehicle, for example in particular the current position and/or the distance traveled and/or the speed information and/or the information relating to driving times and rest times and/or the payload weight and/or the cargo space temperature for monitoring purposes or checking purposes, for example for inspection institutions, or the current position and/or the payload weight and/or the fuel consumption value for a fleet management system or the current position and/or the distance traveled for the determination of a road use fee or toll which is to be paid. In addition, in the event of an accident other vehicles can be warned and/or an emergency call can be dispatched, for example also automatically when the accident is detected.

### BRIEF DESCRIPTION OF DRAWINGS

Exemplary embodiments of the invention are explained in the text which follows on the basis of the schematic drawings, in which:

FIG. 1 is a first embodiment of a system with external communication parties;

FIG. 2 is a second embodiment of the system; and

FIG. 3 is the system with external communication parties.

Elements of identical design or function are provided with the same reference symbols throughout the figures.

### DETAILED DESCRIPTION OF DRAWINGS

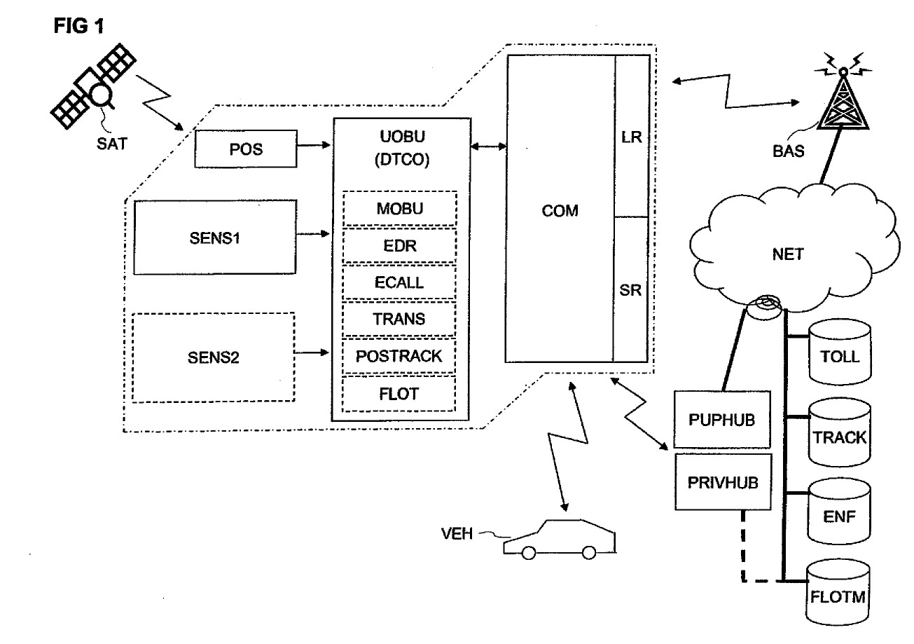

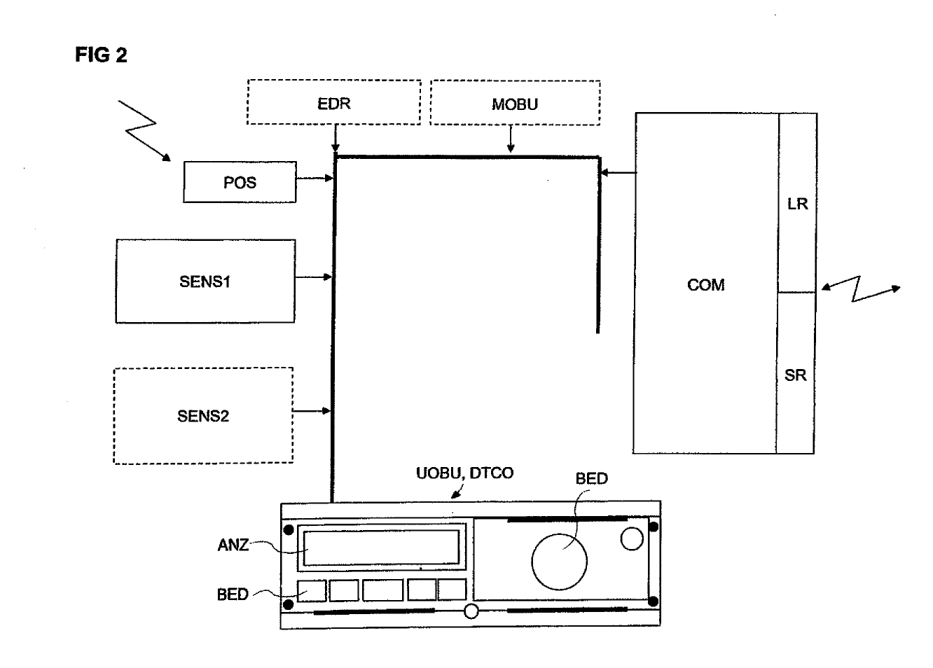

A system comprises an on-board unit UOBU, which is embodied as a tachograph DTCO and, in particular, as a digital tachograph DTCO (FIG. 1 and FIG. 2). The system also comprises at least one position-determining device POS and/or at least one radio communication device COM. The system preferably comprises both the at least one position-determining device POS and the at least one radio communication device COM. These can either be coupled to the on-board unit UOBU in order to be able to be used by the on-board unit UOBU, for example by a vehicle data bus, in particular a “Controller Area Network” or for short CAN, a “Local Interconnect Network” or for short LIN, or a “Media Oriented Systems Transport” or for short MOST, or they are included in the on-board unit UOBU, that is to say for example integrated therein or arranged thereon. The system is provided for installation in a vehicle and, in particular, for installation in a truck. However, the system can, for example, also be provided for installation in a passenger car or in another vehicle.

The at least one position-determining device POS includes, in particular, a receiver for receiving position information and/or time information from a satellite-supported position-determining system, for example a “Global-Positioning System” or for short GPS, or Galileo or some other position-determining system. The satellite-supported position-determining system is symbolized by a satellite SAT. The at least one position-determining device POS can, however, also be designed to determine a current position in some other way, for example by road maps taking into account accelerations, the velocity and/or the steering angle or the like, for example also by a gyroscope. The at least one position-determining device POS can, for example, be formed by a navigation system that makes available a determined current position, for example via the vehicle data bus.

The at least one radio communication device COM preferably includes long range radio LR and/or short range radio SR. The at least one radio communication device COM includes as long range radio LR, for example, in particular mobile radio, for example “Global System for Mobile Communications” or for short GSM, “Universal Mobile Telecommunications System” or for short UMTS, and/or “General Packet Radio Service” or for short GPRS. In addition, the radio communication device COM can also be designed to use operational radio. The at least one radio communication device COM can comprise as short range radio SR, for example, in particular “Wireless Local Area Network” or for short WLAN, and/or “Dedicated Short Range Communication” or for short DSRC and/or Bluetooth. WLAN is preferably provided according to IEEE 802.11p. The at least one radio communication device COM can, however, also be embodied in a different way and can comprise different technologies or further technologies than those mentioned in the case of long range radio LR and/or short range radio SR.

The on-board unit UOBU can be coupled to at least a first sensor SENS1. The at least one first sensor SENS1 is designed, in particular, to sense a vehicle speed and/or a distance traveled. The at least one first sensor SENS1 can also be designed to sense an acceleration of the vehicle. In addition, at least one second sensor SENS2 can also be provided. The at least one second sensor SENS2 is embodied, for example, as a sensor for sensing a cargo space temperature and/or a payload weight and/or an air humidity value and/or a drinking water consumption value and/or ventilation in the cargo space and/or a fuel consumption value. The at least one first sensor SENS1 and/or the at least one second sensor can also comprise further sensors. The at least one first sensor SENS1 comprises, in particular, those sensors which are necessary for operation of the tachograph DTCO, for example owing to legal requirements. In contrast, the at least one second sensor SENS2 comprises, in particular, those sensors which are provided optionally for applications such as, for example, fleet management FLOTM, vehicle course monitoring TRACK or transport monitoring, for example for monitoring transportation of animals. The on-board unit UOBU preferably has access to measured values of the at least one first sensor SENS1 and of the at least one second sensor SENS2.

The on-board unit UOBU comprises at least one function of at least one of the following vehicle devices: a toll collection unit MOBU and/or an event data capture device EDR and/or an emergency call device ECALL and/or a transport monitoring device TRANS and/or a vehicle course monitoring device POSTRACK and/or a fleet management device FLOT. The on-board unit UOBU can in addition also comprise at least one function of at least one further vehicle device which is not included in this enumeration. The on-board unit UOBU is designed to replace the vehicle device, respectively provided in the vehicle, in relation to this respective at least one function, that is to say the respective vehicle device does not have to have this function itself in order to be able to use it. The on-board unit UOBU is preferably designed to replace a functionality of the respective vehicle device completely, that is to say the on-board unit UOBU preferably comprises all the necessary functions of the respective vehicle component, and this vehicle component is therefore integrated into the on-board unit or included in it.

Owing to the integration of functions of vehicle devices that the tachograph DTCO does not usually have and are not necessary for the prescribed operation thereof and owing to the universality of the tachograph DTCO and of the on-board unit UOBU which is achieved thereby, the tachograph DTCO or the on-board unit UOBU can also be referred to as a “Universal On-Board Unit”. The number and/or complexity of vehicle devices in the vehicle can therefore be reduced without having to dispense with the functionality thereof. The functionality of the vehicle devices is partially or completely integrated into the on-board unit UOBU whose basis is formed by the tachograph DTCO, which is in any case already prescribed at least in the European Union for vehicles over 3.5 tonnes.

The vehicle devices provided in the vehicle and are partially or completely integrated into the on-board unit UOBU preferably make joint use of the at least one position-determining device POS and/or of the at least one radio communication device COM. As a result, the vehicle devices do not have to have a respective separate position-determining device POS and/or radio communication device COM. The at least one position-determining device POS and/or the at least one radio communication device COM can be embodied as separate modules or can be arranged in the on-board unit UOBU or can be arranged in one of the vehicle devices. If the at least one position-determining device POS and/or the at least one radio communication device COM is arranged in one of the vehicle devices, for example in the toll collection unit MOBU which is embodied separately, the latter are, however, not provided for exclusive use by this vehicle component but instead can also be used by other vehicle devices and/or the on-board unit UOBU. The on-board unit UOBU can be designed to coordinate or control the use of the at least one position-determining device POS and/or of the at least one radio communication device COM by the vehicle components.

The at least one position-determining device POS and the at least one radio communication device COM do not have to be arranged in or on the same vehicle component or both in or on the on-board unit UOBU but rather can be embodied separately from one another as a separate module, arranged in or on the on-board unit UOBU or arranged in or on one of the vehicle components or can be arranged distributed between two or among more than two vehicle components. For example, the long range radio LR and the short range radio SR of the radio communication device COM can be embodied separately from one another and arranged at different positions or in different vehicle components. It is also possible, for example, to provide that the at least one radio communication device COM or parts thereof are embodied in the form of what is referred to as a “Download Device” or for short DLD. It is possible to provide, for example, for the latter to be coupled to the on-board unit UOBU via, for example, a front-side interface of the on-board unit UOBU.

The on-board toll collection unit MOBU is designed, in particular, to permit, in cooperation with a toll system operated, for example, by a toll system operator TOLL, automatic billing for road use fees, that is to say tolls and/or controls, for example by supervisory institutions ENF, relating to the billing of road use fees. For this purpose, the on-board toll collection unit MOBU is designed, for example, to determine the current position by the at least one position-determining device POS and to determine, on the basis of predefined route data, whether tolls are obligatory on a section of road currently being traveled on. The on-board toll collection unit MOBU can transmit via the at least one radio communication device COM, in particular via mobile radio, data which has been determined and relate to billing to the toll system operator TOLL which bills the incurred road use fees. The on-board toll collection unit MOBU and the toll system can, however, also be embodied differently.

The at least one radio communication device COM is designed, in particular, to transmit data via a mobile radio base station BAS. The mobile radio base station BAS is coupled, for example, to a network NET, for example to a mobile radio network or to the Internet. The toll system operator TOLL also has, for example, access to the network NET, with the result that the data transmitted via the at least one radio communication device COM, the mobile radio base station BAS and the network NET can arrive at the toll system operator TOLL. Likewise, it is possible to provide that data can correspondingly be transmitted in the opposite direction from the toll system operator TOLL to the at least one radio communication device COM, the on-board toll collection unit MOBU or the on-board unit UOBU.

The event data capture device EDR is designed, in particular, to capture and store data that occurs chronologically in conjunction with at least one predefined event. Such an event can, in particular, be an accident. The accident can, for example, be detected when an airbag is triggered or when accelerations which exceed a predefined threshold value occur. However, it is also possible to provide for the accident to be detected differently.

The event data capture device EDR includes a memory which is operated, in particular, as a ring buffer, that is to say a respective oldest entry in the memory is overwritten by a respective newest entry if the memory is already completely filled with entries. Preferably data and measured values suitable for tracking an accident event, for example with respect to a driver's behavior, vehicle dynamics, status signals and/or signals relating to an activation state of safety systems of the vehicle, are preferably continuously stored in the memory. However, it is also possible to store other data or measured values. For example, it is possible to provide for the current position which is determined by the at least one position-determining device POS to be stored. When the at least one predefined event occurs, the storage of the data and measured values is, for example terminated or ended, for example after the expiry of a predefined time period or after the storage of a predefined number of further data items or measured values after the occurrence of the at least one event. As a result, the stored data or measured values are retained for an evaluation and are not overwritten by new data or measured values. However, the event data capture device EDR can also be embodied in other ways.

The emergency call device ECALL is designed, in particular, to emit an emergency call via the at least one radio communication device COM, in particular via mobile radio. The emergency call device ECALL can, in particular, be embodied according to “a Pan-European automatic in-vehicle emergency call system”, or for short eCall. However, it can also be embodied in other ways. For example, it is possible to set up a connection to an emergency call center or the like. It is possible, for example, to provide that this takes place automatically, for example when an accident is detected automatically, or manually, for example by activation of an operator control element which is provided for this purpose. In addition, it is, for example, possible to provide that the current position, which is determined by the at least one position-determining device POS, is transmitted via the at least one radio communication device COM, with the result that help can be easily and reliably sent to the accident location.

The transport monitoring device TRANS is designed, in particular, to sense predefined data or measured values relating to a cargo, for example by the at least one second sensor SENS2, and to store said data or measured values for monitoring purposes. For example it is possible to provide for a cargo space temperature and/or an air humidity value and/or a payload weight and/or a drinking water consumption value and/or a ventilation value or other relevant data or measured values to be captured and stored, for example in the case of transportation of animals. In particular, it is possible to provide that supervisory institutions ENF can call up the stored data or measured values for monitoring purposes, for example via the at least one radio communication device COM, in order to be able to monitor compliance with specifications and, in particular, legal requirements. It is also possible, for example, to provide that the current position which is determined by the at least one position-determining device POS is stored together with the predefined data or measured values. In addition it is possible to provide that information which is equivalent to data in a logbook is stored and/or, for example, information relating to the opening or closing of a tailgate and/or information relating to the coupling or uncoupling of a towing machine or trailer is stored.

The vehicle course monitoring device POSTRACK is designed, in particular, to transmit the current position, which has been determined by the at least one position-determining device POS, via the at least one radio communication device COM, in particular via mobile radio, in order to carry out the vehicle course monitoring TRACK. The current position is preferably transmitted here at predefined time intervals or in each case after a predefined distance. The vehicle course monitoring TRACK can, for example, be used for the purpose of antitheft protection or for preventing impacts with hazardous loads during transportation. For example, the insurers or government institutions can determine the current position of a vehicle which has been stolen.

The fleet management device FLOT is designed, in particular, to make available the fuel consumption and/or the payload weight and preferably the current position, which has been determined by the at least one position-determining device POS and/or other or further data or measured values, via the at least one radio communication device COM, for the fleet management FLOTM. As a result, route planning or deployment planning for vehicles of a vehicle fleet or of a motor pool can be assisted or made possible.

In addition to the mobile radio base stations BAS or as an alternative thereto it is also possible to provide public access stations PUBHUB which can, in particular, be designed to use the short range radio SR of the at least one radio communication device COM for data communication. Such public access stations PUBHUB can, for example, be arranged on components of road traffic infrastructure, for example on toll bridges or at other suitable locations. The data communication with public access stations PUBHUB can also be referred to as vehicle infrastructure communication or car-to-infrastructure or can comprise such communication. The public access stations PUBHUB preferably permit access to the network NET. In addition, private access stations PRIVHUB can also be provided. For example, companies can provide one or more than one private access station PRIVHUB, in particular for their fleet management FLOTM, and, for example, arrange them at locations where the vehicles of the fleet or of the motor pool usually pass by or park.

In addition it is possible to provide that, via the at least one radio communication device COM, it is possible for there to be data communication with at least one other vehicle VEH which also has a corresponding system with an on-board unit and at least one radio communication device. The data communication between vehicles preferably takes place via short range radio SR. As a result, it is, for example, possible to transmit, in particular, warnings, for example an accident warning, traffic jam warning, fog warning or black ice warning, to other vehicles VEH that are located in the reception range and for which such a warning can be relevant. However, it is also possible to transmit other data or measured values, for example the current position, velocity, external temperature or air humidity, to other vehicles VEH or receive them therefrom. The data communication with the at least one other vehicle VEH can be referred to as vehicle-to-vehicle communication or car-to-car communication. The data communication between vehicles VEH preferably takes place via an ad hoc network which is set up between the vehicles VEH.

In the case of the system as shown in FIG. 1, according to a first embodiment all the functions of at least one of the vehicle devices are preferably integrated into the tachograph DTCO or the on-board unit UOBU. The system which is shown in FIG. 2 according to a second embodiment essentially only differs from the system shown in FIG. 1 in that not all functions of the at least one vehicle device are integrated into the tachograph DTCO or the on-board unit UOBU but rather some of the functions of the at least one vehicle device are embodied or arranged separately from the tachograph DTCO or the on-board unit UOBU, and the latter are coupled to the tachograph DTCO or the on-board unit UOBU, for example via the vehicle data bus. For example, this is indicated in FIG. 2 for functions of the on-board toll collection unit MOBU and of the event data capture device EDR. However, this correspondingly also applies to other functions of the vehicle devices. However, the tachograph DTCO or the on-board unit UOBU comprises at least one function of the at least one vehicle device. This at least one function comprises, for example, a user interface of the respective vehicle device. The user interface comprises, in particular, for example at least one display ANZ and/or at least one operator control element BED. The at least one display ANZ can, for example, comprise a screen and/or LED or small lamp for displaying data, statuses or information and, in particular, a user prompting system. The at least one operator control element BED can, for example, comprise pushbutton keys, knobs, sliding controllers, rotational controllers or the like for operation of the device by a user. The respective vehicle device, the user interface of which is included in the tachograph DTCO or the on-board unit UOBU, must therefore not have a separate user interface and does therefore not need to be arranged in the vehicle in such a way that it is easily accessible by the user. Only the tachograph DTCO or the on-board unit UOBU has to be easily accessible for the user. All of the vehicle devices whose user interface is included in the tachograph DTCO or the on-board unit UOBU can therefore be operated by the tachograph DTCO or the on-board unit UOBU.

The at least one function of the at least one vehicle device that is included in the tachograph DTCO or the on-board unit UOBU can, however, also include, for example, data storage and/or data communication via the at least one radio communication device COM and/or a position-determining process via the at least one position-determining device POS and/or other functions or further functions of the respective vehicle device. The data storage can, in particular, be relevant for the event data capture device EDR and/or the transport monitoring device TRANS. The data communication can, in particular, be relevant for the on-board toll collection unit MOBU, the emergency call device ECALL, the vehicle course monitoring device POSTRACK and/or the fleet management device FLOT. The position-determining process can, in particular, be relevant for the on-board toll collection unit MOBU, the emergency call device ECALL, the vehicle course monitoring device POSTRACK, the fleet management device FLOT and/or a navigation system.

The tachograph DTCO is designed to make available, and suitable for making available, the data storage, if appropriate using cryptographic functions for signing and/or encryption and/or the like. The tachograph DTCO can, in particular, also be designed to protect, and/or be suitable for protecting, the data communication via the at least one radio communication device COM using cryptographic functions for signing and/or checking and/or encryption and/or decryption and/or the like. The tachograph DTCO and correspondingly preferably the on-board unit UOBU is preferably of a secure design in order to be able to ensure a high level of data security and data reliability and protection against tampering. For example, the tachograph DTCO or the on-board unit UOBU corresponds to “IT-SEC E3 high” or “CC EAL4+” or similar security categories.

By bundling functions of preferably two or more than two vehicle devices in the tachograph DTCO or the on-board unit UOBU as well as common use of the position-determining device POS and/or of the radio communication device COM and/or of the user interface, of the data storage functions or cryptographic functions which can be made available by the tachograph DTCO or the on-board unit UOBU, synergies are obtained with potential savings and new application possibilities. The common use of the position-determining device POS and/or of the radio communication device COM and/or of the user interface, of the data storage functions or cryptographic functions means that such devices and functions are not required separately for each of the vehicle devices and can therefore be eliminated therefrom. As a result considerable reduction in costs can be achieved.

For example, an accident which is detected by the event data capture device EDR can be transmitted to other vehicles VEH via the at least one radio communication device COM, preferably together with the current position which is determined by the at least one position-determining device POS. Said vehicles VEH can, if they are equipped with a corresponding system, receive this accident warning, for example via their at least one radio communication device COM, and can drive around the accident point, if appropriate through interaction with a navigation system. Vehicles traveling behind can therefore be warned about the accident, with the result that consequential accidents and, if appropriate, a traffic jam can be avoided. In particular, a predictive, traffic-adaptive driver assistance system is easily and reliably made possible through interaction with the navigation system and/or by digital road maps. In addition it is possible to provide that when the accident warning is received, the system of the other vehicle VEH proposes, through interaction with the navigation system, that the driver drives to a parking place until an obstacle caused by the accident has been removed. This permits adaptive control of rest times as a function of a route to be traveled on and a current traffic situation, with the possibility of influencing the current traffic situation as a function of the accident. In addition it is possible that, triggered by the accident, assistance is summoned by the emergency call device ECALL via the at least one radio communication device COM. In this context, the current position which has been determined by means of the at least one position-determining device POS can preferably also be communicated.

In addition, comfort functions can be supplemented. For example it is possible to provide for a country entry and/or a time comparison and/or resetting to local time to be carried out automatically as a function of the current position which has been determined by the at least one position-determining device POS, with the result that manual inputs relating to the above can be dispensed with. In addition, plausibility checking of data or measured values can be carried out on the basis of the data and measured values available in the tachograph DTCO or the on-board unit UOBU, in particular by virtue of the bundling of the functions. As a result, the protection against tampering can be improved and/or the reliability of the system can be increased.

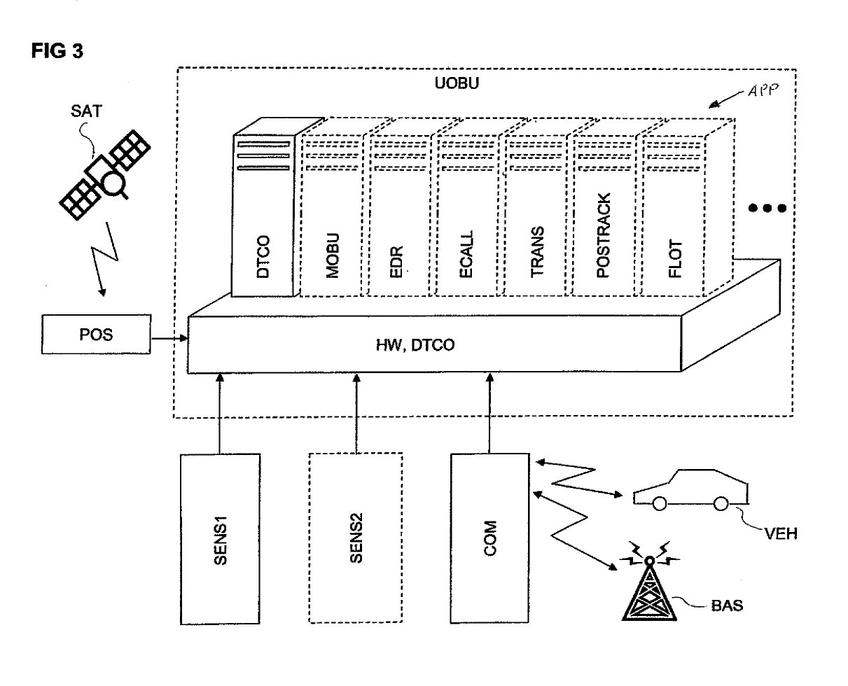

FIG. 3 shows by way of example a possible structure of the on-board unit UOBU. The basis of the on-board unit UOBU is a hardware platform HW. The hardware platform HW comprises, in particular, at least one computing unit, for example a microprocessor or a microcontroller, and at least one data store. The hardware platform HW preferably corresponds essentially to the tachograph DTCO or includes the latter. However, compared to the tachograph DTCO, further components may be provided in the hardware platform HW of the on-board unit UOBU, for example also the at least one position-determining device POS and/or the at least one radio communication device COM and/or specific components of those vehicle devices whose at least one function the on-board unit UOBU has. The hardware platform HW can also comprise basic software, in particular for example an operating system and/or driver for actuating the hardware and/or basic services. The basic services can, for example, comprise use of the at least one position-determining device POS and/or of the at least one radio communication device COM and/or of the cryptographic functions and/or other functions which can be used jointly, for example relating to the user interface. The hardware platform HW also comprises, in particular, at least one interface for coupling to a respective vehicle data bus and at least one interface for coupling to the at least one sensor SENS1 and, if appropriate, the at least one sensor SENS2 if the measured values of such sensors of the on-board unit UOBU are not made available via the vehicle data bus.

The hardware platform HW can also be designed to integrate components of separately embodied vehicle devices and to make available their functionality to other vehicle devices, for example via the basic services. For example, the at least one position-determining device POS can be assigned to the navigation system or to the on-board toll collection unit MOBU or the at least one radio communication device COM can be assigned to the on-board toll collection unit MOBU or to the emergency call device ECALL.

In addition, the on-board unit UOBU includes applications APP, that is to say, in particular, software modules which include the at least one respective function of the at least one vehicle device. The functions of one of the vehicle devices are preferably encapsulated in each application APP. The applications are executed on the hardware platform HW and can use the basic services, data and measured values which are made available. Insofar as the hardware platform HW makes available the required basic services, data and measured values, the functionality of the on-board unit UOBU can easily be extended by providing a further application APP. The on-board unit UOBU can, however, also be embodied differently.

In particular vehicle devices or applications or functions which are provided to meet legal requirements, these being in particular the tachograph DTCO, the on-board toll collection unit MOBU, the event data capture device EDR, the emergency call device ECALL or the transport monitoring device TRANS, are at least partially combined in the on-board unit UOBU. In particular if the functionality of such vehicle devices is integrated completely into the on-board unit UOBU, the advantage is that only the on-board unit UOBU and the at least one position-determining device POS and/or the at least one radio communication device COM have to be provided in the vehicle in order to satisfy the legal stipulations. Other, separately embodied vehicle devices are then no longer necessary under certain circumstances. However, other vehicle devices which are not provided in order to meet the legal requirements can very easily also be integrated into the on-board unit UOBU, these being in particular the vehicle course monitoring device POSTRACK and/or the fleet management device FLOT.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A system comprising
an on-board unit configured as a tachograph, the on-board unit having at least one function of at least one vehicle device, the on-board unit replacing the at least one vehicle device in terms of the at least one function, the at least one vehicle device comprising at least one of a toll collection unit, an events data capture device, an emergency call device, a transport monitoring device, a vehicle course monitoring device, and a fleet management device; and
at least one of a position-determining device and at least one radio communication device that is one of coupled to the on-board unit and included in the on-board unit.

15. The system as claimed in claim 14, wherein the on-board unit has at least one respective function of at least two of the vehicle devices, and these at least two of the vehicle devices are configured to make joint use of the at least one of the position-determining device and the at least one radio communication device.

16. The system as claimed in claim 14, wherein at least one function comprises a user interface.

17. The system as claimed in claim 14, wherein at least one function comprises data storage.

18. The system as claimed in claim 17, wherein on-board unit is configured to secure the data storage cryptographically by at least one of signing and encryption.

19. The system as claimed in claim 14, wherein at least one function comprises data communication via the at least one radio communication device.

20. The system as claimed in claim 19, wherein on-board unit is configured to one or more of to sign, check, encrypt, and decrypt the data communication cryptographically.

21. The system as claimed in claim 14, wherein at least one function comprises a position-determining process by the at least one position-determining device.

22. The system as claimed in claim 14, wherein on-board unit is configured to replace the at least one vehicle device completely.

23. The system as claimed in claim 14, wherein the at least one radio communication device is configured to carry out data communication with a respectively corresponding radio communication device in at least one other vehicle.

24. The system as claimed in claim 14, wherein the at least one radio communication device is designed to carry out data communication via at least one mobile radio base station.

25. The system as claimed in claim 14, wherein the at least one radio communication device is configured to transmit one or more of a current position determined by the at least one position-determining device, a distance that has been traveled, a speed information item, an accident warning, an emergency call, information relating to driving times, rest times, a payload weight, a cargo space temperature, and a fuel consumption value.

26. An on-board unit comprising:
a tachograph; and
at least one of at least one position-determining device and at least one radio communication device coupled to and for use by the tachograph,
wherein the on-board unit has at least one function of at least one of the following vehicle devices to replace the respective vehicle device for at least one function, the vehicle device comprising one or more of a toll collection unit, an event data capture device, an emergency call device, a transport monitoring device, a vehicle course monitoring device, and a fleet management device.
